(19) United States
(12) Patent Application Publication
(10) Pub. No.: US 2005/0265382 A1
(43) Pub. Date: Dec. 1, 2005

(54) Providing control information for a protocol

(75) Inventor: Juha Hartikainen, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/941,011

(22) Filed: Sep. 15, 2004

(30) Foreign Application Priority Data
May 31, 2004 (FI) 20040742

(51) Int. Cl. H04L 12/28

(52) U.S. Cl. 370/465; 370/401

(57) ABSTRACT

A method for providing control information for a protocol is discussed. In the method, information indicating at least one timer value is sent to at least one communications device for configuring at least one timer relating to the protocol used in the at least one communications device. A communications device is also presented, the communications device being configured to receive control information for a protocol, the control information having been sent by a communications network and indicating at least one timer value for the protocol, and to configure at least one timer value relating to a protocol used in the communications device based on the received control information.

### BACKGROUND OF THE INVENTION

The present invention relates in general to providing control information for a communications protocol. In particular the invention relates to providing control information for a protocol used in a communications device.

### FIELD OF THE INVENTION

A communication system can be seen as a facility that enables communication sessions between two or more entities such as user equipment and/or other nodes associated with the communication system. The communication may comprise, for example, communication of voice, data, multimedia and so on. Communication systems providing wireless communication for communications devices, including various user equipment, are known. An example of the wireless systems is the public land mobile network (PLMN). Another example is the wireless local area network (WLAN).

A PLMN is typically a cellular system wherein a base transceiver station (BTS) or similar access entity serves user equipment (UE) such as mobile stations (MS) via a wireless interface between these entities. The operation of the apparatus required for the communication can be controlled by one or several control entities. The various control entities may be interconnected. One or more gateway nodes may also be provided for connecting the cellular network to other networks, such as to another cellular system or to a public switched telephone network (PSTN) and/or other communication networks such as an IP (Internet Protocol) and/or other packet switched data networks.

A cellular network can thus provide access to various services and applications provided by the cellular network or by entities or networks external to the cellular network. The same is true also for other wireless networks connected to further networks. There are proposals for architectures for providing services in an access-network independent manner. As an example, this means providing conference call facilities, can be used by any communications device having certain defined capabilities and accessing the conference call facilities via any access network.

One proposal for providing services independently of the specific access network used by a communications device is the IP Multimedia Subsystem (IMS), defined in the 3rd Generation partnership project 3GPP specifications. The IMS services can be accessed via any access network providing IP connectivity. The General Packet Radio Service (GRPS) relating to the Global System for Mobile Communications (GSM) and the Universal Mobile Telecommunications System (UMTS) are two examples of an IP Connectivity Access Network (ICAN) for IMS.

The IMS, as any communication system, defines various entities for controlling service subscriptions and for providing services to users. In the IMS, these entities are implemented as servers in a network. In order to be able to request for a service from a communication system a user typically needs to have a subscription to the service and needs to be registered in the system in a serving control entity. In the IMS, information about the subscribers (subscribers' profiles) is stored in a home subscriber server (HSS) and the serving control entity is a Serving Call Service Control Function (S-CSCF) entity. A user may register to the serving control entity via an access entity of the communication system. As mentioned above, the IMS is access network independent, so it is sufficient that the access network provides IP connectivity.

In addition to the serving control entity, the user may need to be associated with a proxy control entity. In the IMS, the proxy control entity is the P-CSCF. The proxy entity is assigned to an area within which the user has roamed. For a more general case, when a user accesses the network through an arbitrary type of access network it can be assumed that the access network assigns a proxy control entity for controlling the accessed services from that network point of view, e.g. for bandwidth management.

In the IMS, a call state control function (CSCF) entity may provide functions such as serving call state control (S-CSCF), proxy call state control (P-CSCF), and interrogating call state control (I-CSCF). Control functions may also be provided by entities such as a home subscriber server (HSS) and various application servers.

The communication between the user equipment (communications device) and elements of a communication network is typically based on an appropriate communication protocol or on a set of appropriate communication protocols. A communication system furthermore typically operates in accordance with a given standard or specification which sets out what the various elements of the system are permitted to do and how that should be achieved. Communication protocols and/or parameters which shall be used for a given connection may also be defined. In other words, a specific set of “rules” on which the communication can be based needs to be defined to enable communication by means of the system.

A communications protocol typically defines messages or message sequences relating to various actions and also default actions if, for example, a requested action cannot be carried out. A protocol typically has also various specified time limits for receiving responses to sent messages. If a response is delayed, the protocol typically does not function properly. There may be need to send a message relating to a certain action repetitiously. In a worst case, the requested action is not carried out at all.

One of the control protocols used in the IMS is the Session Initiation Protocol (SIP). SIP is a protocol specified in the Request for Comments RFC 3261 supplied to the Internet Engineering Task Force (IETF). Various timers are specified for SIP in RFC 3261, mainly in Section 17. Annex A of RFC 3261 lists timer values for SIP.

In connection with the IMS, the session initiation protocol is used, for example, for registering to the S-CSCF and for setting up sessions. It shall be appreciated that the term “session” used in this document refers to any communication a user may have such as to a call, data (e.g. web browsing) or multimedia communication and so on. Regarding the delays in receiving a response to a certain SIP message in connection with the IMS, a registration to a S-CSCF may fail or a requested session may not be established.

It has been noted that the SIP timer values specified in RFC 3261 are not necessary long enough for using the IMS and UMTS. This is because of the signaling delays caused, for example, by the air interface in the UMTS. To overcome this problem, longer timer values are specified in Section 7.7 and Table 7.5 of the 3GPP specification TS 24.229, version 5.6.0 Release 5. The 3GPP specification defines first timer values for use between network elements, second timer values for use in user equipment (or, more generally, in a communications device), and third timer values for use in a P-CSCF towards the user equipment.

Timer values in an operator's core network elements should be set according to the values defined in corresponding standards, for example, in the 3GPP standards. The operator can set the timer values using the management system of the network. However, delays in the network can be longer than recommended in standards due to, for example, the size of the network, implementation of the network (different suppliers), the structure and complexity of the network. Therefore an operator may want to use different (typically longer) timer values than specified in standards to guarantee better call success rate for the end users. Timer values in communications devices, such as in mobile phones, are set by the vendor during the manufacturing phase of the terminal. Later, a reseller could modify the values before selling the terminal to an end user. The end user is normally not aware of these timers at all. However, the problem arises when it is not known in which network the terminal will be used, and thus, the correct timer values cannot be configured in advance. Hence, the timer values in the terminal might be too short if the delays in operator's access and core networks are longer than recommended in standards.

There is furthermore at least one problem relating to specifying different timer values for SIP in connection with the IMS and UMTS than for SIP in general. As a communications device may have capabilities to access the IMS via a number of access networks or to use SIP for other purposes than for the IMS, the communications device needs to be able to determine and use correct timer values for ensuring successful control functionality when using SIP.

There are thus problems relating to determining correct SIP timer values for SIP protocol or other control protocols and to take the timer values into use in a communications device.

It shall be appreciated that although the above discussed problems relate to the IMS in third generation communication systems, similar disadvantages may be associated with other systems as well and thus the description is not limited to these examples.

### SUMMARY OF THE INVENTION

It is an aim of embodiments of the present invention to address one or more of the problems discussed above.

A first aspect of the invention provides a method for providing control information for a protocol, said method comprising
sending information indicating at least one timer value to at least one communications device for configuring at least one timer relating to a protocol used in said at least one communications device.

A second aspect of the invention provides a communications device comprising
means for receiving control information for a protocol, the control information having been sent by a communications network and indicating at least one timer value for the protocol, and
means for configuring at least one timer value relating to a protocol used in the communications device based on the received control information.

A third aspect of the invention provides a communications system comprising
means for sending control information indicating said at least one timer value to at least one communications device for configuring at least one timer relating to a protocol used in said at least one communications device.

A fourth aspect of the invention provides a network element for a communications system, said network element comprising
means for sending control information indicating said at least one timer value to at least one communications device for configuring at least one timer relating to a protocol used in said at least one communications device.

A fifth aspect of the invention provides a network element for a communications system, said network element comprising
means for triggering sending of control information indicating said at least one timer value to at least one communications device for configuring at least one timer relating to a protocol used in said at least one communications device.

### BRIEF DESCRIPTION OF THE DRAWINGS

Embodiments of the present invention will now be described by way of example only with reference to the accompanying drawings, in which:

FIG. 1 shows schematically the general architecture of the IP Multimedia Subsystem,

FIG. 2 shows schematically the protocol stack relating to the SIP protocol,

FIG. 3 shows, as an example, schematically a communications system where embodiments of the invention are applicable,

FIG. 4 shows schematically an arrangement in accordance with a first embodiment of the invention,

FIG. 5 shows schematically an arrangement in accordance with a second embodiment of the invention,

FIG. 6 shows, as an example, a message sequence chart relating to the second embodiment of the invention,

FIG. 7 shows schematically an arrangement in accordance with a third embodiment of the invention,

FIG. 8 shows, as an example, a message sequence chart relating to the third embodiment of the invention,

FIG. 9 shows, as an example, schematically a communications system in accordance with an embodiment of the invention, and

FIG. 10 shows schematically, as an example, a communications device for embodiments of the invention.

### DETAILED DESCRIPTION OF EMBODIMENTS OF THE INVENTION

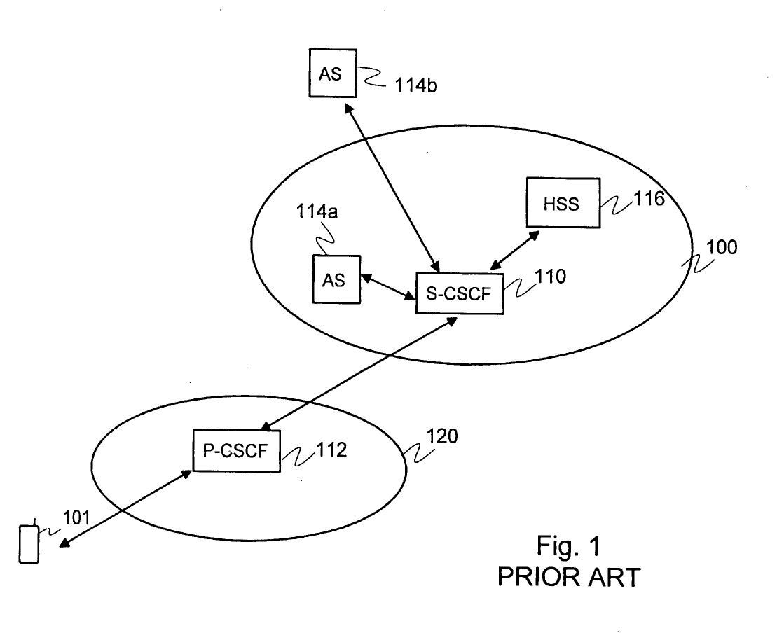

FIG. 1 shows schematically the general architecture of the IP Multimedia Subsystem IMS 100. A user who wishes to use services provided by the IMS may need first to register with a serving controller, such as the serving call session control function (S-CSCF) 110. As shown in FIG. 1, communication between the S-CSCF 110 and the communications device (user equipment UE) 101 may be routed via at least one proxy call session control function (P-CSCF) 112. The P-CSCF 112 is thus for proxying messages to the S-CSCF 110. The communications between the communications device 101 and the P-CSCF 112 are usually provided via an access network 120 or an access entity. Even if it is not shown in the figure, there can be several other elements involved in the connection, such as I-CSCFs. The serving controller, i.e. S-CSCF 110 in FIG. 1, in turn, provides the control entity the user equipment 101 needs to be registered with. The registration is required, for example, to enable the communications device to request for a service from an application server (AS) 114a or 114b or to run end-to-end applications with another user equipment. In certain cases, the S-CSCF may find that the total number of registration processes at a certain moment is too much for the capacity of the S-CSCF. In such a case, the S-CSCF may reject a registration request by sending a response forbidding the registration.

A user information storage entity may also be provided for storing information associated with the subscription of the respective user. The user information storage entity may locate in a server of the home network of the subscription. Such subscriber information storage entities may be called by different terms in different communication systems, and in the IMS the subscriber information storage is called a Home Subscriber Server (HSS). FIG. 1 shows a home subscriber server (HSS) 116. The HSS 116 can be queried by other function entities over the appropriate reference points, e.g. during session set-up procedures and later. The subscriber information may include information such as data required for authentication purposes (e.g. registration identities of the subscriber or the user equipment) and so on. The HSS 116 can also be used for storing permanently subscriber profile information.

The session initiation protocol SIP is used for controlling sessions in the IMS. At least the following entities thus use SIP: the communications device UE, the controlling entity S-CSCF and the proxying entity P-CSCF. The SIP architecture contains, for example, a SIP client, a SIP server, a SIP proxy and a User Agent (UA). A SIP client is any network element that sends SIP requests and receives SIP responses. A SIP server is a network element that receives SIP requests in order to service them and sends back SIP responses to those requests. A SIP proxy is an intermediary entity that acts as both a SIP server and a SIP client for the purpose of making requests on behalf of other SIP clients. A SIP proxy server primarily plays the role of routing. A User Agent is a logical entity that can act as both a user agent client (UAC) and user agent server (UAS). A user agent client is a logical entity that creates a new request, and then uses the client transaction state machinery to send it. The role of UAC lasts only for the duration of that transaction. In other words, if a piece of software initiates a request, it acts as a UAC for the duration of that transaction. If it receives a request later, it assumes the role of a user agent server for the processing of that transaction.

Referring to the IMS, the communications device using the IMS services acts in general as a SIP user agent. The proxy entity P-CSCF acts in general as a SIP proxy, but in some cases also as a SIP User Agent. The controlling entity S-CSCF acts in general as a SIP proxy, but has also some capabilities of a SIP registrar and accepts registering requests. A more detailed description of the capabilities of the communications device (user equipment), S-CSCF and P-CSCF can be found in the 3GPP specification TS 24.229, version 5.6.0, Release 5.

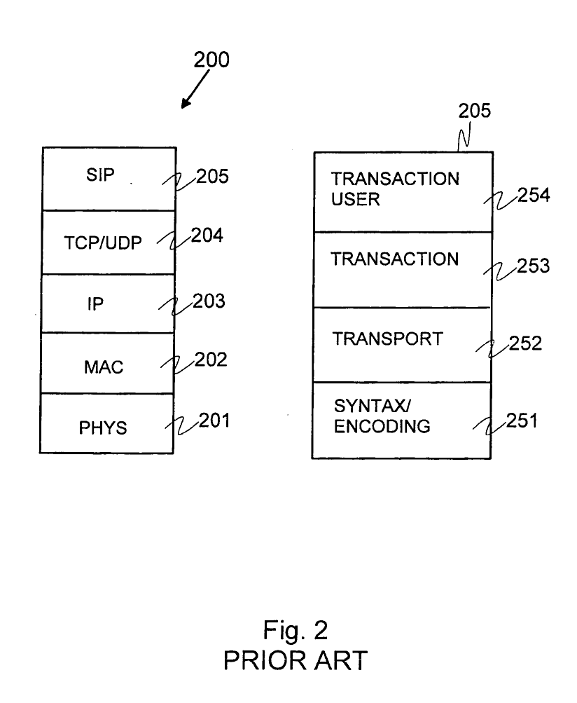

FIG. 2 shows, as an example, a protocol stack 200 relating to the SIP protocol. The lowest protocol layer PHY 201 relates to the physical transport medium. The next protocol layer MAC 202 relates to medium access control. The IP protocol layer 203 is typically provided on top of the MAC layer 202. The transmission protocol layer 204 typically includes at least Transmission Control Protocol (TCP) and User Datagram Protocol (UDP). The SIP layer 205 in on top of the transmission protocol layer 204.

The SIP layer 205, in turn, comprises four sublayers. The lowest sublayer is the syntax/encoding layer 251, which relates to SIP message structures and to encoding of SIP protocol messages for providing payload information to the transmission protocol layer 204. The next sublayer is the transport layer 252, which defines how a SIP client sends requests and receives responses and how a SIP server receives requests and sends responses over the network.

The next sublayer is the transaction layer 253, and on top of the transaction layer 253 is a layer called the transaction user (TU) 254. User agents contain a transaction layer 253, as do stateful SIP proxies. Stateless SIP proxies do not contain a transaction layer 253. The transaction layer 253 has a client component (referred to as a client transaction) and a server component (referred to as a server transaction), each of which are represented by a finite state machine that is constructed to process a particular SIP request. Each of the SIP entities, except the stateless proxy, is a transaction user layer 254. When a TU wishes to send a request, it creates a client transaction instance and passes it the request along with the destination IP address, port, and transport to which to send the request.

Transactions are a fundamental component of the SIP. A transaction is a SIP request sent by SIP client transaction (using the transport layer) to a SIP server, along with all responses to that request sent from the SIP server back to the SIP client. The transaction layer handles application-layer retransmissions, matching of responses to requests, and application-layer timeouts. Any task that a user agent client (UAC) accomplishes takes place using a series of transactions.

SIP is a transactional protocol: interactions between components take place in a series of independent message exchanges. Specifically, a SIP transaction consists of a single request and any responses to that request, which include zero or more provisional responses and one or more final responses. Should there be no response to a given SIP message, a timer in the transaction layer 253 typically expires and causes the state machine to enter a new state.

A number of timers are specified for the SIP. Table 1 lists these timers, refers to relevant Sections of RFC 3261 and briefly explains the meaning of each timer. As Table 1 shows, timer T1 relates to round-trip-time estimate, and a default value is 500 ms. As mentioned above in connection with the discussion of the background art, longer timer values are specified in Section 7.7 and Table 7.5 of the 3GPP specification TS 24.229, version 5.6.0, Release 5. The 3GPP specification defines first timer values for use between network elements, second timer values for use in user equipment (or, more generally, in a communications device), and third timer values for use in a P-CSCF towards the user equipment.

TABLE 1
SIP timers

| | | Section in | |
|---|---|---|---|
| Timer | Value | RFC 3261 | Meaning |
| T1 | 500 ms default | 17.1.1.1 | RTT Estimate |
| T2 | 4 s | 17.1.2.2 | The maximum retransmit interval |
| | | | for non-INVITE requests and |
| | | | INVITE responses |
| T4 | 5 s | 17.1.2.2 | Maximum duration a message will |
| | | | remain in the network |
| Timer | initially T1 | 17.1.1.2 | INVITE request retransmit inter- |
| A | | | val, for UDP only |
| Timer B | 64*T1 | 17.1.1.2 | INVITE transaction timeout timer |
| Timer C | >3 min | 16.6 | proxy INVITE transaction bullet |
| | | | 11 timeout |
| Timer | >32 s for UDP | 17.1.1.2 | Wait time for response |
| D | | | |
| | 0 s for | | retransmits |
| | TCP/SCTP | | |
| Timer E | initially T1 | 17.1.2.2 | non-INVITE request retransmit |
| | | | interval, UDP only |
| Timer F | 64*T1 | 17.1.2.2 | non-INVITE transaction timeout |
| | | | timer |
| Timer | initially T1 | 17.2.1 | INVITE response retransmit |
| G | | | interval |
| Timer | 64*T1 | 17.2.1 | Wait time for ACK receipt |
| H | | | |
| Timer I | T4 for UDP | 17.2.1 | Wait time for 0 s for TCP/SCTP |
| | | | ACK retransmits |
| Timer J | 64*T1 for | 17.2.2 | Wait time for |
| | UDP | | |
| | 0 s for | | non-INVITE request retransmits |
| | TCP/SCTP | | |
| Timer | T4 for UDP | 17.1.2.2 | Wait time for |
| K | | | |
| | 0 s for | | Response retransmits |
| | TCP/SCTP | | |

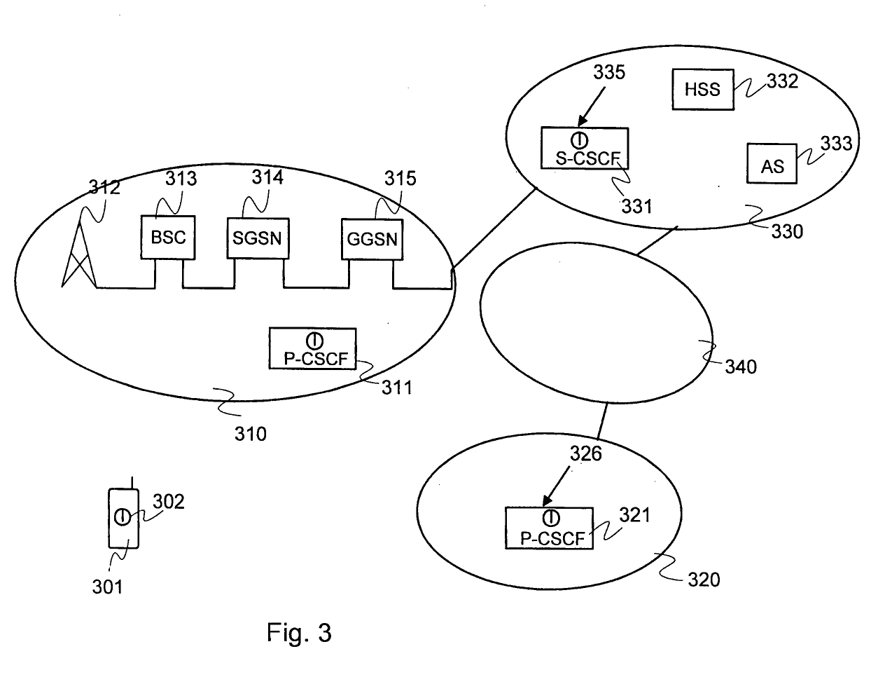

FIG. 3 shows schematically a first communications system 300a, a second communications system 300b, and a communications device 301, as an example of a system where embodiments of the invention are applicable. The communications system 300a contains, as an example, an access network 310 and a core network 330. FIG. 3 shows only an access network 320 relating to the second communications system 300b. The two access networks 310 and 320 can be geographically separate or they may be implemented using different protocols and equipment. Both the first access network 310 and the second access network 320 are able to provide Internet Protocol (IP) connectivity for the communications device 301. FIG. 3 shows, as an example, that the first access network 310 is connected directly to the core network 330. The second access network 320 is connected to the core network 330 via, for example, a public IP network 340. It is alternatively possible that the second access network 320 is also directly connected to the core network 330. The communication system 300a is the home network of the user using the communications device 301 in that sense that the core network 330 contains the controlling entity S-CSCF 331 and the home subscriber server HSS 332. Also an application server AS 333 is shown in the core network 330.

It is clear to one skilled in the art that any packet data protocol may be applicable as an alternative to the Internet Protocol. As the IMS refers to IP, the IP is used here as an example of a packet data protocol. It is also clear to one skilled in the art that the IMS architecture is an example, and any service architecture having similar functionality and similar controlling and proxying functionality and/or entities may be used. Furthermore, the SIP protocol is here used as an example of a protocol having timers, specifically as an example of a control protocol.

The first access network 310 and the second access network 320 are typically wireless networks. FIG. 3 illustrates the first access network 310 to be a GPRS network. The first network 310 is shown to contain a base station BS 312, a base station controller 313, and a serving GPRS Supporting Node SGSN 314 and a Gateway GPRS Supporting Node GGSN 315. The GGSN usually connects the packet switched part of the GPRS network 310 usually to an IP backbone network. Further examples of access networks are Enhanced Data rates for GSM Evolution (EDGE), Wireless Local Area Networks (WLAN), Operator Wireless Local Area Network (OWLAN), radio access network of the UMTS or radio access network of the Wideband CDMA system (WCDMA).

Even if both the first access network 310 and the second access network 320 were in accordance with the same standards and specifications, for example both are GPRS networks, the transmission delays may be quite different in these networks. The delays are typically, for example, due to the radio access network elements and packet switched network elements. In the GPRS example, the radio access network elements are the base stations and base station controllers and the packet switched network elements are the SGSN and the GGSN. Also on the size and load of the access network and those of the IP backbone network, for example, may affect the delays. Equally sized networks may have different delays due to the fact that the network elements have been manufactures by different vendors. A certain network may be usually very busy, whereas another network may usually have a very light load. Furthermore, it is possible that the delays are dependent on the location of the communications device within the coverage area of the access network.

When the communications device 301 is accessing a service provided by the application server AS 333 via the first access network 310 different SIP timer values may thus be applicable than when the communications device 301 is accessing the service via the second access network 320. As FIG. 3 shows, the communications device has at least one timer 302 relating to the control protocol, more specifically to the SIP protocol. The proxying entities P-CSCF 311 and 321 also have at least one timer 316, 326 relating to the control protocol. The controlling entity S-CSCF 331 also has at least one timer 335 relating to the control protocol.

It is appreciated that typically a network element, for example, a serving entity S-CSCF or a proxying entity P-CSCF, has a set of timer values that it uses for controlling all sessions. If a network element has session-specific timers or user-specific timers, these can be configured to have same values as those in a communications device whose session the network element is controlling. This configuration can be done, for example, using the normal configuration and management interfaces of a network.

It is possible to measure and determine delays relating to a certain network or to a certain part of a network for determining suitable timer values for the SIP timers. Similarly, if for example a delay relating to an IP backbone network are significant, the SIP timer values can be chosen so that they take these into account as well.

One specific example of a SIP protocol timer, which may need configuring, is the roundtrip timer, namely timer T1. The roundtrip timer is used in the INVITE transaction of the SIP protocol, discussed in Section 17.1.1.1 of the RFC 3261. The INVITE transaction consists of a three-way handshake. The client transaction sends an INVITE message, the server transaction sends responses, and the client transaction sends an ACK message. For unreliable transports (such as UDP), the client transaction retransmits requests at an interval that starts at T1 seconds and doubles after every retransmission. T1 is an estimate of the round-trip time (RTT), and it defaults to 500 ms in accordance with the RFC 3261. As table 1 shows, many other timers scale with T1. This means that changing T1 adjusts the values of these other timers as well.

For controlling the SIP protocol, timer values are sent from the communications system to the communications device 301. The communications device 301 may be provided with functionality to receive configuration or control information from the communications network. One example of sending and receiving configuration or control information is the Over-the-Air (OTA) interface. Usually configuration or control information is provided by the home network (the communication system 300a in FIG. 3) or by a visited network (the communication system 300b in FIG. 3).

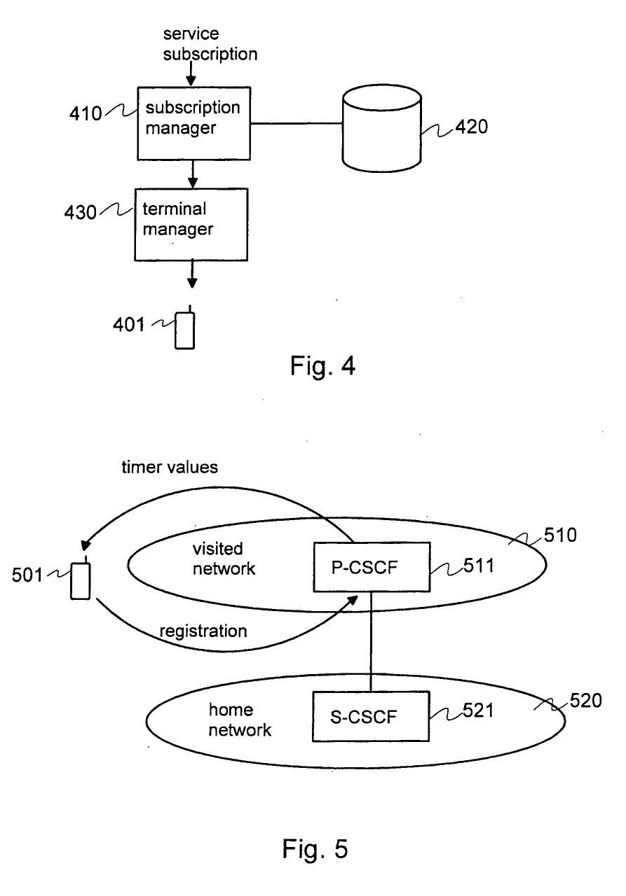

FIG. 4 shows schematically an arrangement in accordance with a first embodiment of the invention. The first embodiment of the invention relates to service subscriptions, for example to a user subscribing to an IMS service. The service subscription manager 410 in FIG. 4 is an example of an entity responsible for service subscriptions. The service subscription manager may receive service subscriptions, for example, from management personnel. A further example is that a user may subscribe to a service by accessing a WWW page. It is evident that there are many other possibilities for entering service subscription information to a service subscription manager 410. Upon receiving a service subscription, the service subscription manager 410 stores information about the user and the subscribed service, for example, to a store for storing service subscription information (not shown in FIG. 4). In IMS, for example, information about service subscriptions is stored in the HSS.

In the first embodiment of the invention, the timer values suitable for use in the home network are sent to the communications device 401 of the user subscribing to the service. The timer values suitable for use with the home network are sent because the communications device 401 may have preset timer values in the user's communications device, which are different from the suitable timer values for the home network. Alternatively, the communications device 401 may lack any preset timer values. For sending the suitable timer values, the service subscription manager 410 may fetch timer values for the home network from an information store 420. The timer values may be stored, for example, in a suitable network element. The timer values for the control protocol, for example for SIP in connection with the IMS, are sent to the user's communications device 401 for example via a terminal manager 430.

The timer values may be sent by the terminal manager 430 using, for example, an Over-The-Air (OTA) interface or using SyncMI. The OTA interface refers to sending control information to a communications device using short messages (SMS). The OTA interface relates to client provisioning and device management, and it is specified by Open Mobile Alliance. In this case the user may need to explicitly accept the received timer values. The SyncML is based on a client-server solution, and the communications device 401 thus contains a client application, which may be able to receive and save the timer values without user interaction. It is appreciated that there may be many other possibilities to send the timer values to the communications device 401. It is furthermore appreciated that the timer values may be sent together with other control information. One example of such other control information is IMS parameters sent to a communications device 401 after the IMS subscription for enabling the user of the communications device to access IMS services.

FIG. 5 shows schematically an arrangement in accordance with a second embodiment of the invention. This second embodiment of the invention is suitable for delivering timer values especially to a roaming user. In FIG. 5 the IMS architecture is used as an example. The roaming user's communication device 501 registers itself to the serving control entity S-CSCF 521 via a proxying control entity P-CSCF 511. The proxy control entity P-CSCF 511 is in a visited network 510, and the serving control entity S-CSCF 521 is in the home network 520.

The SIP timer values in use in the communications device 501 when the communications device enters the visited network 510 may be, for example, default SIP timer values in accordance with the relevant 3GPP standards. As a second example, the timer values may have been set by the home network of the user of the communications device 501 when the IMS service was subscribed to. The visited network 510 may use different SIP timer values. The communications device 501 and the proxy control entity P-CSCF 511 should employ same SIP timer values for making session initiation reliable and successful. Therefore the visited network may send information indicating at least one timer value to the communications device 501 of a roaming user.

FIG. 5 shows schematically one example of sending SIP timer values. The proxying control entity P-CSCF 511 may send the information indicating at least one SIP timer value. More particularly, the proxying control entity P-CSCF 511 may send the timer values in a SIP protocol message. The communications device 501 needs to be configured to take the received SIP timer values into use before continuing with further SIP message exchanges. In practice this means that the SIP protocol stack may need to be configured on the fly. Should the communications device 501 not be able configure the SIP protocol stack or to process received timer values, it may ignore the received SIP timer values and continue to use the current timer values.

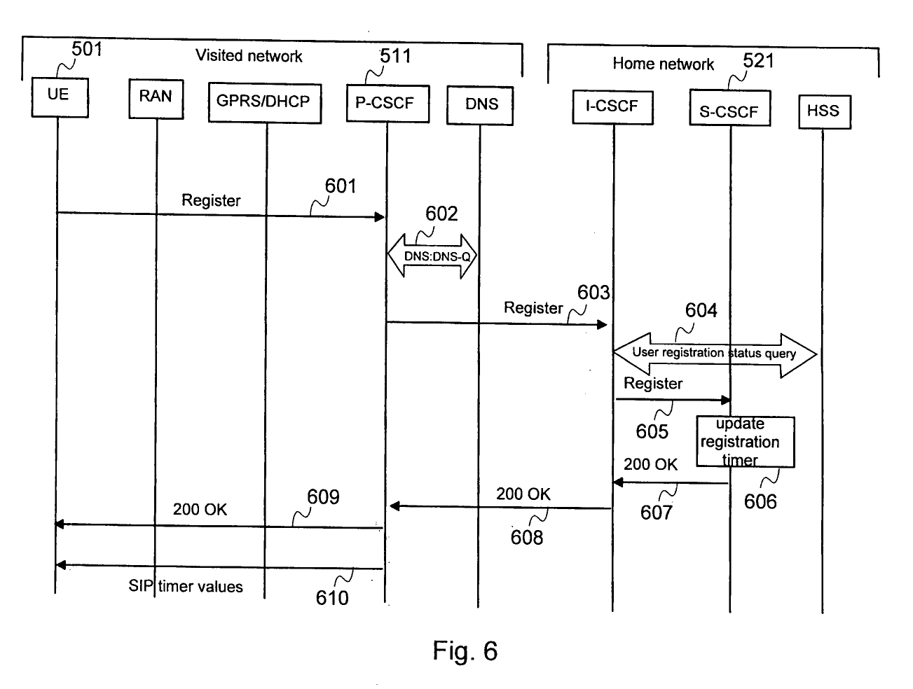

FIG. 6 shows, as an example of sending SIP timer values using SIP protocol messages, a message sequence chart relating to the second embodiment of the invention. FIG. 6 shows a message sequence chart for re-registration when a user is roaming. The roaming user's communications device 501 sends a registration message 601 to the proxying control entity P-CSCF 511. Based on the roaming user's identifier present in the registration message 601, for example based on a Uniform Resource Identifier (URI), the proxying control entity P-CSCF 511 determines that the user is registering from a visiting domain and performs Domain Name Server (DNS) queries (arrow 602 in FIG. 6) to locate an interrogating control entity I-CSCF in the home network 520. The DNS provides the P-CSCF 511 with the address of the I-CSCF in the home network 520. Thereafter the proxying control entity P-CSCF 511 forwards the registration message 603 to the interrogating control entity I-CSCF in the home network 520. The interrogating control entity I-CSCF, in turn, carries out a user registration status query (arrow 604) with the HSS in the home network 520. Thereafter the interrogating control entity forwards the registration message 605 to the serving control entity S-CSCF 521 in the home network 520. The serving control entity S-CSCF 521 may, in the simplest case, just update a registration timer (step 606 in FIG. 6). Alternatively, the S-CSCF may carry out also other tasks. Thereafter the serving control entity S-CSCF 521 replies with a 200 OK message 607 to the interrogating control entity I-CSCF. The interrogating control entity I-CSCF forwards the 200 OK message 608 to the proxying control entity P-CSCF, which in turn forwards the 200 OK message 609 to the communications device 501. Section 6.3 of the 3GPP specification TS 24.228, version 5.6.0, Release 5 discusses the message chart of FIG. 6 in further detail.

The SIP timer values may be sent from the proxying control entity P-CSCF 511 to the communications device 501 after the 200 OK message 609. FIG. 6 shows this as a message 610. Alternatively, it may be possible to replace the 200 OK message 609 with the new message 610. This second option, however, may require more changes to the current SIP protocol than the first option.

With respect to FIG. 4, it is appreciated that alternatively the interrogating control entity I-CSCF or the serving control entity S-CSCF 521 in the home network 520 may trigger a terminal manager in the home network 520 to send SIP timer values to the communications device 501. In this case the suitable SIP timer values may be fetched, for example, from a database based on the address or identity of the proxying control entity P-CSCF 511. Alternatively, the proxying control entity P-CSCF 511 or other entity in the visited network 510 may transmit the timer values to the home network 520 for sending the timer values to the communications device 501.

It is also appreciated that if, for example, a serving control entity S-CSCF 521 is triggering the sending of information indicating timer values, the timer values may be sent to the user irrespectively of whether the user is in the home network 520 or in a visited network 510. The timer values should, however, be values suitable for use in that network where the user currently is.

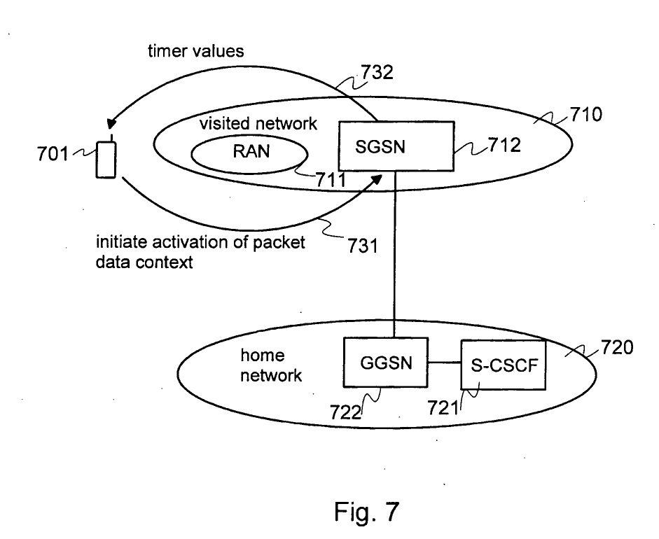

FIG. 7 shows schematically an arrangement in accordance with a third embodiment of the invention. This third embodiment of the invention is also suitable for sending timer values to a roaming user. The IMS and GPRS are used in FIG. 7 as examples. FIG. 7 shows a roaming scenario, which is called GPRS roaming. The radio access network 711 and a serving GPRS support node (SGSN) 712 are in the visited network 710. The gateway GPRS support node (GGSN) 722 and the serving control entity S-CSCF 721 are in the home network 720. The roaming communications device 701 initiates activation of a packet data context with the SGSN 712, as shown with arrow 731. In response, the SGSN 712 sends information indicating at least one timer value for a SIP protocol (arrow 732 in FIG. 7).

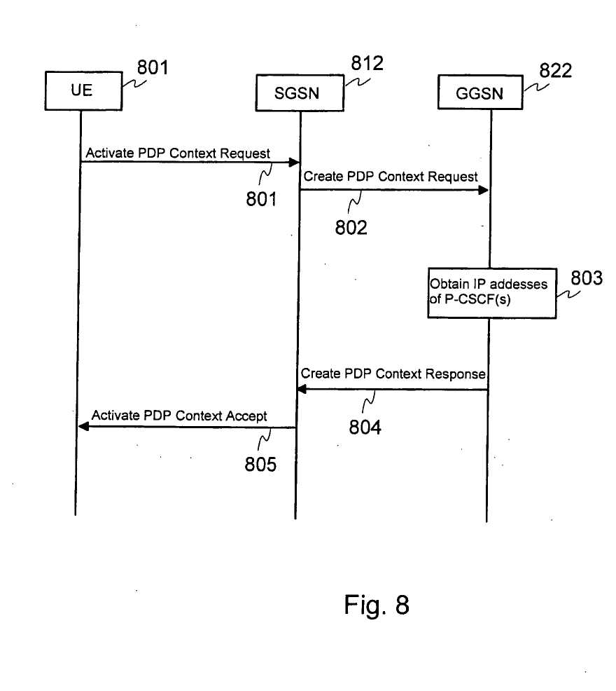

FIG. 8 shows, as an example of the third embodiment of the invention, a message sequence chart relating to a GPRS procedure for P-CSCF discovery. The roaming communications device 701, the SGSN 712 and the GGSN 722 are shown in FIG. 8. The communications device 701 requests establishment of a packet data context by sending an Activate PDP Context Request 801 to the SGSN 712. This Activate PDP Context Request 801 may contain an explicit request for SIP timer values, or the SGSN may interpret this message 801 as a request for SIP timer values. The SGSN 712 selects a GGSN and sends a Create PDP Context Request to the selected GGSN 722. The GGSN 722 obtains the address of the proxying control entity P-CSCF (step 803 in FIG. 8). Thereafter the GGSN 722 sends to the SGSN 712 a Create PDP Context Response 804. Upon receiving this message, the SGSN 712 send to the communications device 701 an Activate PDP Context Accept message 805. The SIP timer values may form a part of this message 805, or they may be sent in an additional message.

Further details relating to FIG. 8 are found in Section 5.2.3 of the 3GPP specification TS 24.228, version 5.6.0, Release 5.

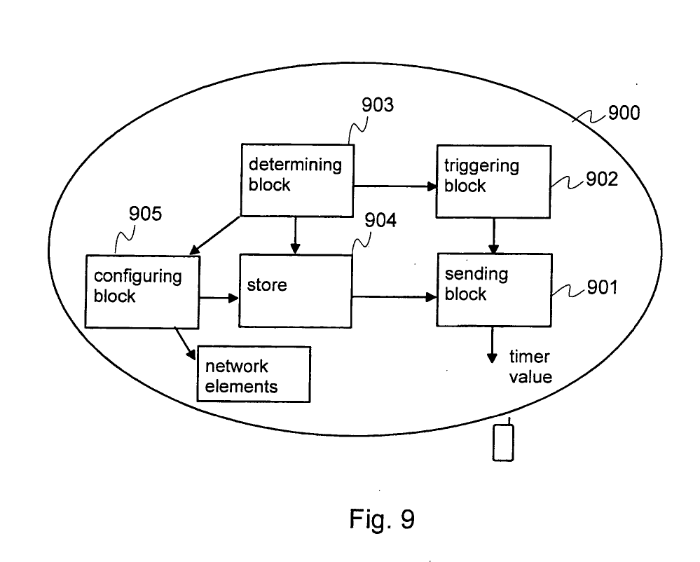

FIG. 9 shows, as an example, schematically a communications system 900 in accordance with an embodiment of the invention are applicable. It is appreciated that the functional blocks shown in FIG. 9 may be implemented in various network elements.

The sending block 901 is responsible for sending information indicating at least one timer value for a protocol used in a communications device. Some examples of network elements, where the sending block 901 may be implemented, are a terminal manager 430, a proxying control entity P-CSCF 511 and a SGSN 712. The triggering block 902 is responsible for triggering sending of the timer values. It is possible that the triggering block 902 is implemented together with the sending block 901. Some examples of network elements, where the triggering functionality may be implemented, are a subscription manager 410, a serving control entity S-CSCF 521 (typically separately from the sending block 901), a proxying control entity P-CSCF 511 (typically together with the sending block 901), and a SGSN 712 (typically together with the sending block 901). The triggering block 902 can also be located somewhere in an operator's management interface, in particular in case the operator decides to configure the timer values of many or all the terminals connected in the network.

FIG. 9 also shows a timer value determining block 903, which is responsible for determining timer values based on the communications system performance. The determining block 903 may store the timer values in a store 904. The sending block 901 may access the timer values from the store 904. The determining block 903 may also inform the triggering block 902 that new timer values should be sent to a number of communications devices. These communications devices may be, for example, the communications device currently using the communication system. The arrangements in FIGS. 5 and 7 may be applicable here. Alternatively, a home network may send new timer values to users of the home network currently present in the home network.

A configuring block 905 is responsible for configuring new timer values to relevant network elements. Examples of the relevant network elements are the proxying control entity P-CSCF for roaming users and the service control entity S-CSCF for users in their home network.

It is appreciated that blocks 903, 904 and 905 in FIG. 9 are typically implemented in a network operator's network management system.

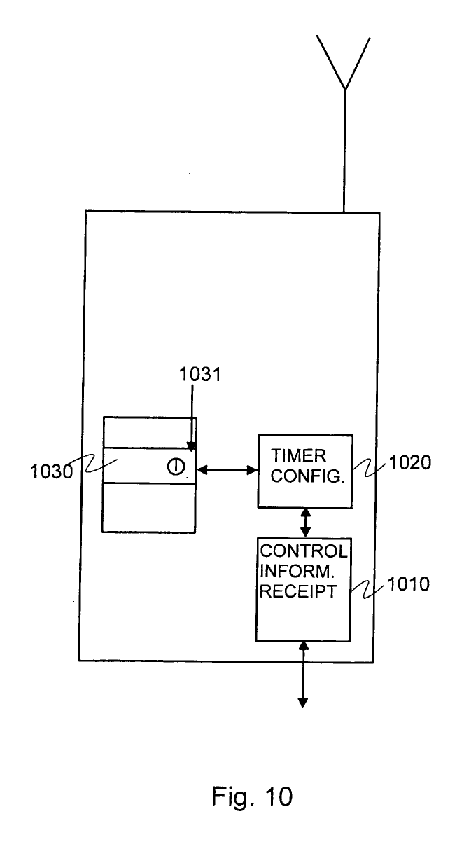

FIG. 10 shows, as an example, schematically a communications device 1000 where embodiments of the invention are applicable. The communications device 1000 contains functionality 1010 for receiving information indicating at least one timer value sent by a communications system. The communications device 1000 contains also functionality 1020 for configuring at least one timer 1031 relating to a protocol 1030. Typically this timer configuring functionality 1020 is provided as an application, which is arranged to configure the relevant protocol stack. Regarding the SIP protocol, at least one timer relating to the transaction layer 253 is configured to have a new value.

The timer configuring functionality 1020 may be arranged to store at least one previous value 1021 for the timers relating to the protocol, typically the previous set of timer values. Storing at least one previous timer value (a previous set of timer values) may be useful, for example, in the case where a roaming communications device enters a new network and the new network has no functionality for sending information indicating at least one timer value. If it is noticed, for example, by a repeated failure to register to the S-CSCF, that the latest set of timer values defined too strict timer values, the previous set of timer values may be taken into use. Alternatively, the timer configuring functionality 1020 may be arranged to store a default set of timer values. These default values may be used when the new access network does not send any information indicating timer values for the control protocol. A further option is that the timer configuring functionality 1020 is arranged to store two sets of default time values: a first set of timer values relating to the home network and a second set of timer values relating to a visited network. In this case, when the communications device enters a new network, the timer configuring functionality 1010 may be told whether the new network is the home network or a visited network and it may update the protocol timers accordingly.

It is appreciated that although in the detailed description above the session initiation protocol SIP is used as an example of a control protocol and the IMS is used as an example of service providing architecture, the invention is applicable with other protocols, control protocols and service architectures/frameworks.

It is appreciated that in the appended claims registration to a service framework refers to actions carried out between a communications device and relevant network entities of the service framework for enabling the communications device to access services of the service framework. The IMS is used above as a specific example of a service framework. The registration to the service framework may be carried out, for example, automatically upon a communications device entering a visited access network or entering the home access network.

It is appreciated that sending information indicating at least one timer value to a communications device for configuring a protocol in the communications device may be applicable also in other connections than in service frameworks such as the MS. For example, information indicating timer values may be sent to a communications device upon entering a visited access network, for example when the communications device roams in a visited cellular communications network.

It is furthermore appreciated that in the appended claims sending information indicating at least one timer value in connection with a certain procedure, for example in connection with registering to a service framework or with activating a packet data context, refers to sending said information as part of the procedure. Typically the information is sent using message(s) of the same protocol which is used for the procedure.

It is also appreciated that the communications device may be any communications device capable of communicating with a communications system and having the necessary functionality for accessing and using services. Examples of communications devices are user equipment, mobile telephones, mobile stations, personal digital assistants, laptop computers and the like. Furthermore, a communications device need not be a device directly used by human users.

Although preferred embodiments of the apparatus and method embodying the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

1. A method for providing control information for a protocol, the method comprising:
sending information indicating at least one timer value to at least one communications device for configuring at least one timer relating to a protocol used in said at least one communications device.

2. The method as defined in claim 1, further comprising:
triggering said step of sending information indicating said at least one timer value in response to a given action.

3. The method as defined in claim 2, wherein, in said step of triggering, said given action comprises entering an access network.

4. The method as defmed in claim 2, wherein, in said step of triggering, said given action comprises subscribing to a service.

5. The method as defined in claim 2, wherein, in said step of triggering, said given action comprises registering to a service framework.

6. The method as defined in claim 2, wherein, in said step of triggering, said given action comprises activating a packet data context.

7. The method as defined in claim 2, wherein said step of sending information indicating said at least one timer value is carried out in connection with said given action.

8. The method as defined in claim 7, wherein said given action is carried out using a protocol and, in said step of sending, said information indicating said at least one timer value is sent using said protocol

9. The method as defined in claim 2, wherein, in said step of triggering, said given action comprises determining at least one of said at least one timer value based on performance of a communications system.

10. The method as defined in claim 9, wherein, in said step of sending, said information indicating said at least one timer value is sent to a plurality of communications devices.

11. The method as defined in claim 1, wherein, in said step of sending, said information indicating said at least one timer value is sent via a terminal management interface.

12. The method as defined in claim 1, further comprising:
determining said at least one timer value based on performance of a communications system.

13. The method as defined in claim 12, wherein the step of determining said at least one timer value comprises determining at least one delay in said communications system.

14. The method as defined in claim 1, further comprising:
storing said at least one timer value in a network management element.

15. The method as defined in claim 1, further comprising:
querying said at least one timer value from a network management element before sending said information indicating said at least timer value to said at least one communications device.

16. The method as defined in claim 1, wherein, in the step of sending, the information is sent for configuring a session control protocol.

17. The method as defined in claim 1, wherein, in the step of sending, the information is sent for configuring a session initiation protocol SIP.

18. A communications device, comprising:
means for receiving control information for a protocol, the control information having been sent by a communications network and indicating at least one timer value for the protocol; and
means for configuring at least one timer value relating to the protocol used in the communications device based on the control information.

19. The communications device as defined in claim 18, wherein said means for receiving said control information is configured to receive said control information over a terminal management interface.

20. The communications device as defined in claim 18, wherein said means for receiving said control information is configured to receive said control information in connection with subscribing to a service.

21. The communications device as defined in claim 18, wherein said means for receiving said control information is configured to receive said control information in connection with activating a packet data context.

22. The communications device as defined in claim 18, wherein said means for receiving said control information is configured to receive said control information in connection with registering to a service framework.

23. The communications device as defined in claim 18, wherein said means for receiving said control information is configured to receive said control information in connection with entering an access network.

24. A communications system, comprising:
means for sending control information indicating at least one timer value to at least one communications device; and
means for configuring at least one timer relating to a protocol used in said at least one communications device.

25. The communications system as defined in claim 24, further comprising:
means for triggering said means for sending said control information.

26. The communication system as defined in claim 25, wherein said means for triggering is configured to trigger at least in response to a given action relating to a communications device and said means for sending said control information is configured to send said control information to the communications device.

27. The communications system as defined in claim 26, wherein said given action comprises subscribing to a service.

28. The communications system as defined in claim 26, wherein said given action comprises registering to a service framework.

29. The communications system as defined in claim 26, wherein said given action comprises entering an access network.

30. The communications system as defined in claim 26, wherein said given action comprises activating a packet data context.

31. The communications system as defined in claim 25, wherein said means for triggering is configured to trigger at least in response to determining said at least one timer value in said communications system.

32. The communications system as defined in claim 25, further comprising:
means for determining said at least one timer value based on performance of said communications system.

33. The communications system as defined in claim 32, configured to store said at least one timer value in a network management element.

34. The communications system as defmed in claim 25, configured to query said at least one timer value from a network management element before sending said control information indicating said at least one timer value to said at least one communications device.

35. A network element for a communications system, said network element comprising:
means for sending control information indicating at least one timer value to at least one communications device; and
means for configuring at least one timer relating to a protocol used in said at least one communications device.

36. The network element as defined in claim 35, wherein said network element comprises terminal management functionality.

37. The network element as defined in claim 35, wherein said network element comprises service framework registration functionality.

38. The network element as defined in claim 35, wherein said network element comprises packet data context activation functionality.

39. A network element for a communications system, said network element comprising:
means for triggering sending of control information indicating at least one timer value to at least one communications device; and
means for configuring at least one timer relating to a protocol used in said at least one communications device.

40. The network element as defined in claim 39, wherein said network element comprises service subscription functionality.

41. The network element as defined in claim 39, wherein said network element comprises service framework registration functionality.

42. The network element as defined in claim 39, wherein said network element comprises packet data context activation functionality.

43. A communications device, comprising:
a receiver configured to receive control information for a protocol, the control information having been sent by a communications network and indicating at least one timer value for the protocol; and
a controller configured to configure at least one timer value relating to the protocol used in the communications device based on the control information.

44. A communications system, comprising:
a transmitter configured to send control information indicating at least one timer value to at least one communications device; and
a controller configured to configure at least one timer relating to a protocol used in the at least one communications device.

45. A network element for a communications system, said network element comprising:
a transmitter configured to send control information indicating at least one timer value to at least one communications device; and
a controller configured to configure at least one timer relating to a protocol used in said at least one communications device.

46. A network element for a communications system, said network element comprising:
a first controller configured to trigger sending of control information indicating at least one timer value to at least one communications device; and
a second controller configured to configure at least one timer relating to a protocol used in said at least one communications device.
